(19) United States
(12) Patent Application Publication
(10) Pub. No.: US 2014/0152007 A1
(43) Pub. Date: Jun. 5, 2014

(54) Managing Efficiency of a Pool of Engine-Driven Electric Generators

(71) Applicant: DEIF A/S, Skive (DK)

(72) Inventors: Claes Høll Sterregaard, Skive (DK); Søren Dahl Christensen, Skive (DK); Allan Schmidt, Skive (DK)

(73) Assignee: DEIF A/S, Skive (DK)

(21) Appl. No.: 13/705,523

(22) Filed: Dec. 5, 2012

(51) Int. Cl. H02P 9/02

(52) U.S. Cl. CPC H02P 9/02
USPC 290/7

(57) ABSTRACT

Systems and methods of managing a pool of engine-driven electric generators. An example method may include populating an efficiency database with fuel provided and electrical power output data for each of the engine-driven electric generators in the pool. The method may also include receiving a desired electrical power output from the pool of the engine-driven electric generators. The method may also include adjusting fuel provided to at least one of the engine-driven electric generators in the pool to generate the desired electrical power output using the efficiency database.

### CROSS REFERENCE TO RELATED APPLICATION

This application is related to U.S. application Ser. No. 13/705,426 titled “MANAGING EFFICIENCY OF AN ENGINE-DRIVEN ELECTRIC GENERATOR” by Claes Høll Sterregaard, et al. [Attorney Docket No. 3700-001-USP] and U.S. Application No. [To Be Inserted After Filing] titled “EMULATING POWER SYSTEM OPERATIONS” by Claes Høll Sterregaard, et al. [Attorney Docket No. 3700-003-USP] filed on the same date, the entire contents of which are hereby incorporated by reference as though fully set forth herein.

### BACKGROUND

Electric power generators are operated as a backup electricity source for critical facilities such as hospitals in the event of an outage. Power generators are also operated in remote locations which cannot be readily connected to the power grid infrastructure (e.g., located “off-grid”).

While alternative power sources are becoming more commonplace (e.g., solar panel and wind turbine installations), electric power generators that burn carbon-based fuels are still the predominant means of providing a reliable source of backup, grid-supplement and/or off-grid electricity. The term “carbon-based fuels” includes for example, but is not limited to, dry gas such as hydrogen, methane or butane; wet gas such as petrol/gasoline; and oil fuels such as diesel or heavy fuel oil.

Given the seemingly ever-increasing costs of carbon-based fuel, and customer sensitivities to variable operating costs, a stronger solution is needed to provide a reliable source of backup, grid-supplement and/or off-grid electricity while effectively managing operating costs.

### BRIEF DESCRIPTION OF THE DRAWINGS

FIG. 1 is a high-level illustration of an example engine-driven electric generator environment in which an efficiency management system may be utilized.

FIG. 2 is a schematic diagram illustrating implementation of an example efficiency management system for a pool of engine-driven electric generators.

FIG. 3 is a process flow diagram illustrating an example architecture to manage efficiency of an engine-driven electric generator.

FIG. 4 is a plot of example data which may be stored in an efficiency database for an engine-driven electric generator.

FIGS. 5a-b are plots of example data which may be stored in efficiency databases for a pool of engine-driven electric generators.

FIG. 6 is a flowchart illustrating example operations which may be implemented to manage efficiency of an engine-driven electric generator.

### DETAILED DESCRIPTION

Electric power generators that burn carbon-based fuels are used predominantly for providing a reliable source of backup, grid-supplement and/or off-grid electricity. These electric power generators often operate reciprocating engines burning carbon-based fuels. Efficiency of a reciprocating engine is a function of the fuel delivered to the engine relative to the rotational energy the engine delivers to the shaft. In terms of an electric power generator, and more specifically, alternating current generators, the efficiency of the generator varies with power output.

The systems and methods described herein manage operation of a pool (or “power island”) of engine-driven electric generators (or “gen-sets”) to increase or even optimize efficiency for desired output of the pool. The term “gen-set” is used herein to describe the combination of an engine and the electrical generator driven by the engine. Individual gen-sets operating in parallel with other sources may be operated at a set point (e.g., electrical output measured in kilowatts or KW). As used herein, the term “efficiency” (unless specifically stated otherwise) is not used to refer to engine efficiency, but rather efficiency of the gen-set. In an example, gen-set efficiency refers to the rotational energy required to produce a given quantity of electricity. In general, efficiency increases as fuel provided to the engine (e.g., usage or consumption by the engine) decreases and electricity production increases.

Multiple gen-sets operating together in a pool may each operate at different efficiencies for a variety of reasons. For example, an older gen-set may operate more efficiently at a given output, while a new gen-set may operate more efficiently at a different output. Therefore, selecting a common set point for each of the gen-sets may be inefficient. By way of illustration, if a pool of ten gen-sets is needed to output 10 megawatts (MW) of power, then a set point of 1 MW may be selected for each of the ten gen-sets such that 1 MW times 10 gen-sets is equal to an output of 10 MW. But if one of the gen-sets can be operated more efficiently at 800 KW, another gen-set can be operated more efficiently at 1200 KW, and so on, then the same power output can still be achieved while enhancing the overall operating efficiency of the pool of gen-sets. Indeed, some of the gen-sets may even be operated at less than optimal efficiency in order to achieve an overall higher efficiency for the pool of gen-sets as a whole.

The systems and methods described herein may be utilized to reduce fuel consumption of multiple gen-sets in a pool by adjusting the set point of gen-sets on an individual basis, to more efficient set points. In an example, the systems and methods may be implemented for a pool of gen-sets operated in parallel with a utility (e.g., the “grid”). The term “set point” generally refers to an operator-entered value (e.g., the desired output from the pool of gen-sets) and may be entered as a unit of electrical power (e.g., KW). For example, the operator may input (a) the power output desired from the pool of gen-sets (e.g., demand, based on load) and (b) a window or tolerance.

Efficiency of the pool of gen-sets may be measured by measuring the fuel delivered to each of the gen-set's reciprocating engines, and comparing the fuel delivery to electrical power being produced by the pool of the gen-set generators. Efficiency information may be stored and used as a set point for a power regulator. The pool of gen-sets may then be configured to operate at the most efficient level by using the fuel consumption data of the engines and the electrical power produced by the pool of generators to determine individual set points to enhance efficiency of the pool of gen-sets.

Operating data may be stored in memory as a reference for future operations. Thus, the system may continuously compensate for changes in actual operating conditions, such as, but not limited to variations in fuel quality, combustion air quality, location (e.g., altitude), environmental conditions (e.g., seasonal and weather-related changes), and age-based factors of the machinery.

In an example, the systems and methods described herein may be applied to operation of reciprocating engine-driven alternating current (AC) generators in a more efficient manner. As such, the systems and methods may reduce fuel consumption, reduce emissions (e.g., carbon emissions and NO_{X}), while further reducing operating and maintenance costs. The pool of gen-sets thus provide a reliable source of backup, grid-supplement and/or off-grid electricity while effectively managing operating costs.

Before continuing, it is noted that as used herein, the terms “includes” and “including” mean, but is not limited to, “includes” or “including” and “includes at least” or “including at least.” The term “based on” means “based on” and “based at least in part on.”

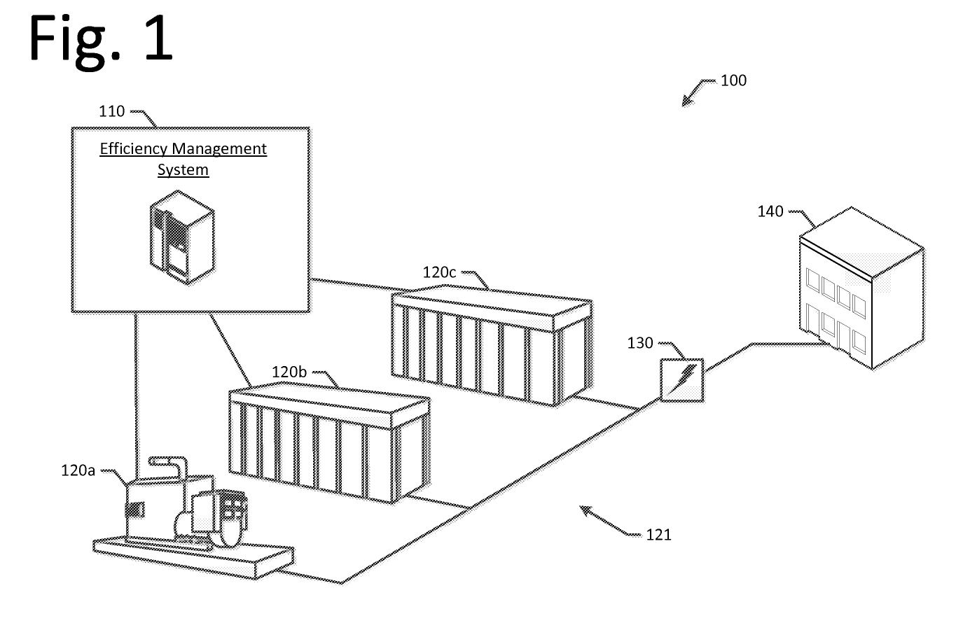

FIG. 1 is a high-level illustration of an example engine-driven electric generator environment 100 in which an efficiency management system 110 may be utilized for a pool of gen-sets. In an example environment, electric power generators may provide a backup electricity source for critical facilities in the event of an outage and/or in remote locations which cannot be readily connected to the power grid infrastructure. Although not to be considered limiting, a common use of electric power generators is illustrated in FIG. 1 where the electric power generators 120a-c are operating in parallel to generate electric power 130 (e.g., 480 volts alternating current or VAC) for a utility 140 (e.g., the power company). Numerous other examples of such environments 100 also exist, and the efficiency management system 110 described herein may be utilized in any such environment.

In FIG. 1, an electric power generator 120a is shown as equipment, and electric power generators 120b-c are shown as the equipment may be housed in a container (e.g., similar to shipping containers). Other examples may include housing the electric power generators in a trailer (e.g., for easy transport) or in a dedicated facility, such as an out-building or other structure.

In an example, the electric power generators are engine-driven electric generators (or “gen-sets”). Each gen-set is a combination of an engine (or prime mover) and an electrical generator, typically mounted together to form a single piece of equipment. Fuel storage, cooling and exhaust systems are provided for the engine. The gen-sets may also include control mechanisms (not shown) such as an engine governor, a voltage regulator, and a power conditioner, to name only a few examples.

The engine may be a reciprocating engine. A reciprocating engine uses one or more piston to convert pressure into rotation, similar to an internal combustion engine in a car or other vehicle. Each piston may have a cylinder, in which the fuel is introduced. The fuel is heated by ignition of an air-fuel mixture (or by contact with a heat exchanger), such that the heated fuel expands and pushes the piston inside the cylinder. The piston returns to the initial position in the cylinder by power exerted from other pistons connected on the same shaft, or by the same process on the other side of the piston. Exhaust is removed from the cylinder and the process repeats, generating rotation of a drive shaft. The drive shaft may be used in turn to power the generator.

The generator converts mechanical energy from rotation of the drive shaft into electrical energy. An alternator uses a rotating field winding and a stationary winding (the “stator”) that produces alternating current (AC). The alternator may be operated at a speed corresponding to a specified frequency to produce AC. It may be necessary to accelerate the alternator to the correct speed and phase alignment to produce proper AC output for the application.

Gen-sets are available having a wide range of power ratings, and the gen-set is typically sized and selected for the pool based on the load that is being powered. But reciprocating engines operate most efficiently at output levels that are different than the rated output (so-called “nameplate” output). For example, a reciprocating engine may operate more efficiently at about 75 to 85% of the rated or full-load capacity of the engine. Electric power generators run by a reciprocating engine typically range from 80 to 98% efficient. In addition, different gen-sets may operate at different efficiencies. This fairly wide range in efficiencies can lead to extremely variable operating costs.

The efficiency management system 110 may be implemented to operate the gen-set(s) 120a-c in a more efficient manner (as a whole, together as the pool), reducing fuel consumption, carbon and other environmental emissions. The efficiency management system 110 may further reduce maintenance costs.

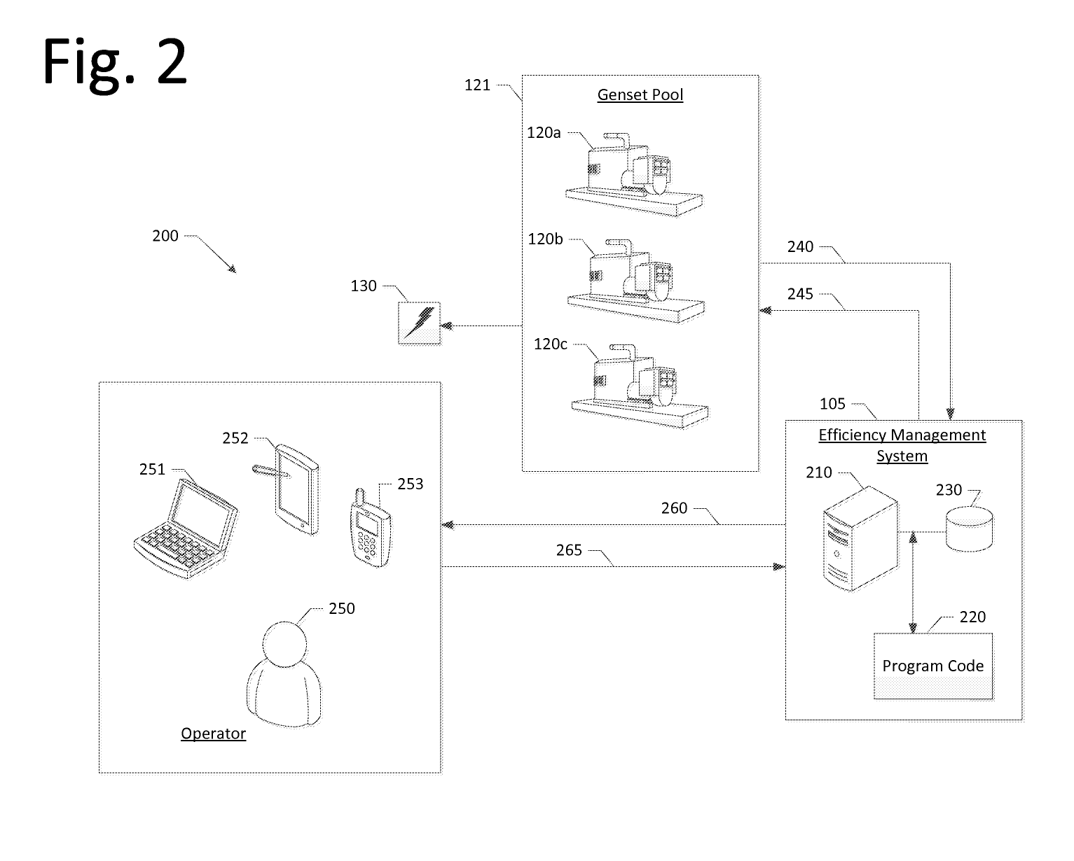

FIG. 2 is a schematic diagram 200 illustrating implementation of an example efficiency management system 110 for a pool 121 of engine-driven electric generators 120a-c. The efficiency management system 110 may be implemented with any of a wide variety of devices. In an example, a computing device 210 includes sufficient processing capability to execute program code 220 stored on a computer readable media 230. The efficiency management system 110 may be provided on-site with the pool of gen-sets 120a-c (e.g., as part of the gen-set equipment or housed separately), partially on-site, or off-site from the gen-set 120 (e.g., at a remote monitoring/control location).

The efficiency management system 110 may interface with control circuitry for each gen-set 120a-c. For example, the efficiency management system 110 may receive operating data from the individual gen-sets 120a-c, as illustrated by input line 240. Example input data includes, but is not limited to, fuel consumption and electrical power output 130. The efficiency management system 110 may also provide output to the individual gen-sets 120a-c, as illustrated by output line 245. Example output data includes, but is not limited to, a fuel control signal which may be used to adjust (increase or decrease) fuel to one or more of the gen-sets 120a-c. The fuel control signal may also include air data (e.g., quality, flow, etc.) and/or air-to-fuel ratio for combustion.

The efficiency management system 110 may also interface with an operator 250. For example, the efficiency management system 110 may receive input from the operator 250, as illustrated by input line 260. For example, input from the operator may include a desired electrical power to be generated or output by the individual gen-sets 120a-c during a given time (e.g., a “window of time”). The desired electrical power output may be constant and/or change based on any of a wide variety of different parameters (e.g., power demand, seasonal adjustments). The efficiency management system 110 may also provide output to the operator 250. Example output to the operator may include current operating conditions of the gen-sets 120a-c, efficiency data, and warnings or alerts.

Before continuing, it is noted that the computing devices and control circuitry implemented by the efficiency management system 110 and gen-sets 120a-c are not limited in function. The computing devices may also provide other services in the efficiency management system 110. For example, the operator devices illustrated in FIG. 2 may be the operator's laptop computer 251, tablet device 252, mobile device 253, or other general-purpose computing device. In addition, there is no limit to the type or amount of data that may be utilized (i.e., received, processed, and/or output) by the efficiency management system 110. In addition, the data may include unprocessed or “raw” data from control circuitry at the gen-sets 120a-c, or the data may undergo at least some level of pre-processing.

In an example, the program code 220 has access to both input from the gen-sets 120a-c and the operator 250. For example, the program code 220 may be implemented as dedicated circuitry built-in or otherwise integrated as part of the gen-sets 120a-c. Or for example, the program code 220 may be implemented in a cloud-based service, wherein the program code is executed on at least one computing device local to the gen-sets 120a-c, but having access to the operator 250 via the Internet or dedicated cloud network.

The program code 220 may be implemented as machine readable instructions (such as but not limited to, software and/or firmware), which may be executed for performing functions of the efficiency management system 110. The machine-readable instructions may be stored on a non-transient computer readable medium and are executable by one or more processor to perform the operations described herein. It should be understood that various functions may also be implemented in control circuitry, such as but not limited to, logic circuits. For example, the efficiency management system 110 may operate on a variety of digital electronic controls including but not limited to PLC's and dedicated purpose digital controllers, any of which may operate using the algorithms described herein.

Briefly, the efficiency management system 110 receives fuel consumption data from an engine control computer (or from an external fuel control device). The efficiency management system 110 compares the fuel requirements with electricity being produced (e.g., measured in Watts or Kilowatts) by the gen-sets 120a-c. Efficiency data is stored in memory of a controller and communicated by a communication link with the other components of the efficiency management system 110. This data may be analyzed and an output issued to control fuel which efficiently runs a reciprocating engine of the gen-sets 120a-c to drive the desired AC power output.

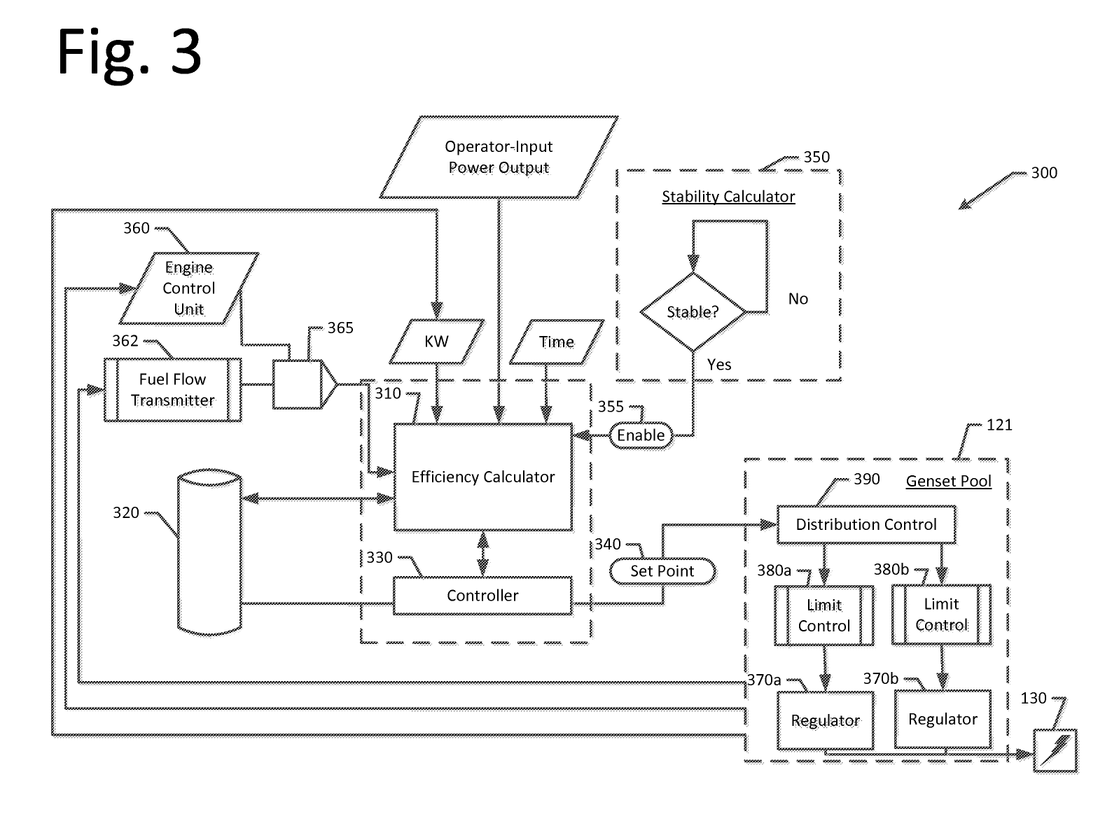

Function of the efficiency management system 110 in combination with the gen-sets 120a-c can be better understood with reference to FIG. 3. It is noted, however, that the components shown in FIG. 2 are provided only for purposes of illustration of an example operating environment, and are not intended to limit implementation to any particular system. The functions described herein are not limited to any specific implementation with any particular type of program code and control circuitry.

FIG. 3 is a process flow diagram 300 illustrating an example architecture to manage efficiency of a pool of engine-driven electric generators (or gen-sets). Briefly, the efficiency management system 110 may include an efficiency calculator 310 configured to populate an efficiency database 320 with fuel usage and electrical power output data for efficient operation of the engine-driven electric generator. Although one database 320 is shown in FIG. 3, it is noted that the organizational structure is not limited. For example, the organization structure may include a master database having separate data stores corresponding to each gen-set, or individual databases for each gen-set.

The efficiency management system 110 may also include a controller 330 operatively associated with the efficiency calculator 310 and the efficiency database 320. The controller 330 is configured to issue a new set point 340 for fuel consumption by the individual gen-sets for efficient operation while generating the desired electrical power output. It is noted that the set point 340 may be different for each of the gen-sets.

By way of illustration, the set point 340 for one of the gen-sets may correspond to an output of 800 KW, the set point 340 for another gen-set may correspond to an output of 1200 KW, and so on, to achieve the same power output from the pool 121 of gen-sets while enhancing the overall operating efficiency of the pool 121 of gen-sets. In an example, one or more of the gen-sets may be shut off entirely. In another example, the operation of one or more of the gen-sets may be reduced below the most efficient level of operation if it is expected that this would be more efficient over time as opposed to shutting and restarting a gen-set (due to the inefficiencies of a power cycle/start-up).

A stability calculator 350 may employ an averaging algorithm to accommodate variable efficiencies during acceleration and deceleration the gen-sets 120a-c. For example, the stability calculator 350 may wait for an efficiency reading to stabilize before determining an efficiency reading is valid for the efficiency database when values are changing. Once the efficiency reading has stabilized, the stability calculator 350 may issue an enable signal 355 to the efficiency calculator to populate the efficiency database 320.

An electrical metering device (or multiple devices) may provide the electrical power output data of each gen-set 120 for the efficiency database 320. For example, a digital engine control unit (ECU) 360 may provide the fuel data for the efficiency database 320. ECU is a generic name for one of many engine control and protection devices that are commercially available from a variety of manufacturers. Information may be read from the ECU via a digital communications link. The ECU supplies the fuel, for example, in terms of liquid measure per unit of time (e.g., liters or gallons per minute or hour).

In another example, an analog transmitter 362 may provide the fuel data for the efficiency database 320. Analog transmitters convert the fuel volume (e.g., dry or liquid carbon based fuels, but may also include other sources of energy such as compressed gas or liquid) into an electrical signal that can be read by the efficiency calculator 310. The units of this signal may be liquid measure of fuel per unit of time or a volume of dry gas per unit of time (e.g., liters or gallons per minute or hour).

A configuration parameter may be used by selection device 365 to select the source of information, from either the ECU 360 or analog device 362. The power output of the gen-sets 120a-c may also be available from a variety of electrical metering devices.

A regulator 370 (regulators 370a-b are shown corresponding to gen-sets 120a-b) may be used to control output of the gen-sets 120a-c, for example, based on individual set points received by the distribution control 390. A limit control (controls 380a-b are shown corresponding to gen-sets 120a-b) on the regulator 370 may maintain generating the desired electrical power output within an acceptable range (e.g., a threshold) specified by an operator.

During operation, the efficiency calculator 310 determines the new set point(s) 340 by determining a maximum/minimum value for the desired overall electrical power output from the pool 121. The efficiency calculator 310 finds the new set point(s) within the maximum/minimum value in the efficiency database. The controller 330 then adjusts fuel provided to the corresponding engine-driven electric generator(s) by issuing a signal to substitute the new set point 340 from the efficiency database 320 with a current set point operating the individual gen-set 120, when the new set point corresponds to a higher operating efficiency of the corresponding gen-set 120 than the current set point. In an example, the efficiency calculator 310 updates the efficiency database 320 and may also determine new set points 340 on a substantially continuous basis during operation of the gen-set 120.

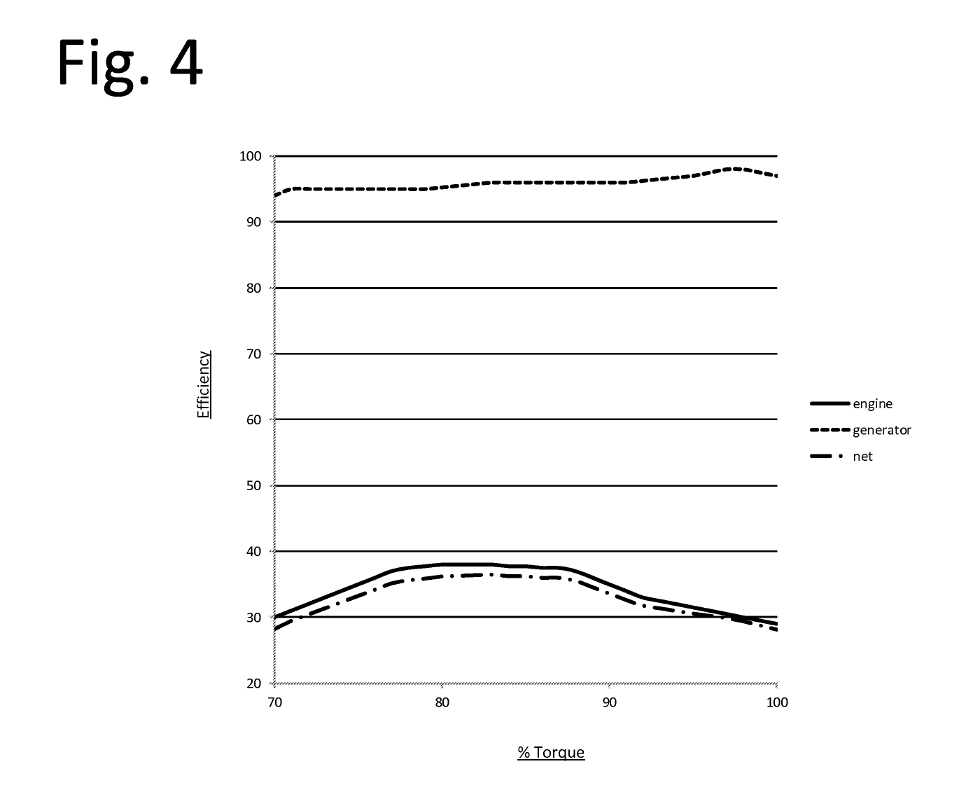

FIG. 4 is a plot of example data which may be stored in an efficiency database for an individual gen-set. It is noted that the database(s) include efficiency data for each of the individual gen-sets. The actual data used to generate the plot 450 is shown in Table 1.

It is noted that an individual gen-set cannot be overall any more efficient than its engine. By way of example, typical diesel engines top out at about 35-38% efficient at full load. These efficiencies and the data in Table 1 (illustrated in plot 450), however, are provided only by way of illustration and are not intended to be limiting.

TABLE 1
Genset Efficiency Data

| % Torque | engine | generator | net |
|---|---|---|---|
| 70 | 30 | 94 | 28.2 |
| 71 | 31 | 95 | 29.45 |
| 72 | 32 | 95 | 30.4 |
| 73 | 33 | 95 | 31.35 |
| 74 | 34 | 95 | 32.3 |
| 75 | 35 | 95 | 33.25 |
| 76 | 36 | 95 | 34.2 |
| 77 | 37 | 95 | 35.15 |
| 78 | 37.5 | 95 | 35.62 |
| 79 | 37.75 | 95 | 35.86 |
| 80 | 38 | 95.25 | 36.19 |
| 81 | 38 | 95.5 | 36.29 |
| 82 | 38 | 95.75 | 36.38 |
| 83 | 38 | 96 | 36.48 |
| 84 | 37.75 | 96 | 36.24 |
| 85 | 37.75 | 96 | 36.24 |
| 86 | 37.5 | 96 | 36 |
| 87 | 37.5 | 96 | 36 |
| 88 | 37 | 96 | 35.52 |
| 89 | 36 | 96 | 34.56 |
| 90 | 35 | 96 | 33.6 |
| 91 | 34 | 96 | 32.64 |
| 92 | 33 | 96.25 | 31.76 |
| 93 | 32.5 | 96.5 | 31.36 |
| 94 | 32 | 96.75 | 30.96 |
| 95 | 31.5 | 97 | 30.55 |
| 96 | 31 | 97.5 | 30.22 |
| 97 | 30.5 | 98 | 29.89 |
| 98 | 30 | 98 | 29.4 |
| 99 | 29.5 | 97.5 | 28.76 |
| 100 | 29 | 97 | 28.13 |

In this example, efficiency of the corresponding an individual gen-set may be quantized as power in divided by power out (or power generated). The power out is determined by the engine efficiency (e.g., fuel usage divided by rotation of the engine), generator rotation divided by power output, or genset fuel consumption divided by power output. Overall efficiency of the pool 121 of gen-sets may be determined by maximizing the efficiency of each of the individual gen-sets, for an overall power output of the pool 121.

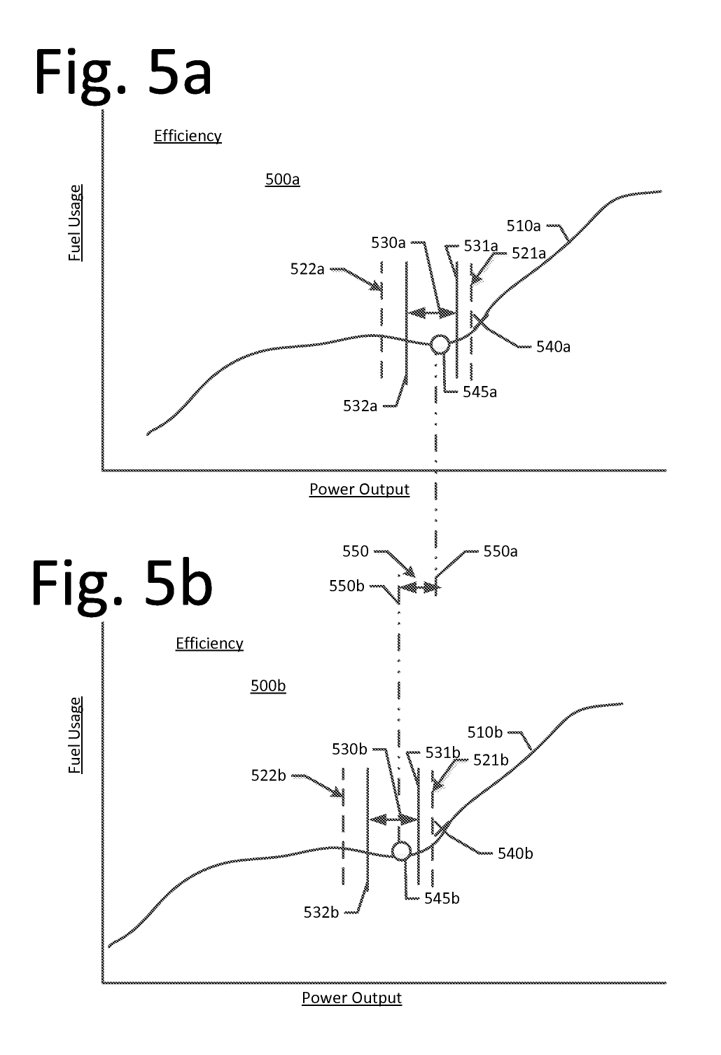

It can be seen from the plot of the data shown in Table 1 that efficiency peaks between 80-90% torque, and hence the operations described herein may be used to target operation of the corresponding gen-set in this range, for example, as described below with reference to the plots shown in FIGS. 5a-b.

FIGS. 5a-b are plots 500a and 500b of example data which may be stored in an efficiency database. Each plot 500a and 500b corresponds to an individual gen-set (e.g., gen-set 120a and 120b, respectively). The plots 500a-b include data points 410 for fuel consumption or usage (shown along the y-axis) corresponding to power output (shown along the x-axis). Accordingly, the data points 510 represents efficiency data at various operating conditions of the gen-set. Fuel usage may be measured and represented in any suitable manner, for example as liters per hour (LPH). Likewise, power output may be measured and represented in any suitable manner, for example as kilowatts (KW).

The efficiency calculator processes the efficiency data from fuel consumption and power output. As described above with reference to FIG. 3, fuel data is available from a variety of digital and/or analog metering devices, and power output data is available from a variety of electrical metering devices. Units of time may be available from any source of accurate time keeping, such as a clock internal to the processing device.

Efficiency calculations may vary as the individual gen-set is increasing or decreasing acceleration, and so the readings may be checked by an averaging algorithm for consistency. If readings are changing over time, stability calculator waits until the readings are stable before determining the value is valid. Valid values of efficiency are then written into the efficiency database to be stored for use later.

It is noted that the efficiency database may be pre-populated (e.g., before executing the efficiency management system 110) with manufacturer test data and/or extrapolated from manufacturer performance specifications for the corresponding gen-set. In another example, populating the efficiency database is by dynamic self-populating during operation of the engine-driven electric generator. Populating the efficiency database may be both pre-populated and dynamically updated. Of course, if pre-populating of data is not handled during initializing/startup/commissioning phase of the gen-set, the efficiency management system 110 may not be brought online to adjust fuel usage until sufficient data points have been collected to populate the efficiency database for a range of operation.

Once populated, the efficiency database may include data as illustrated by plots 500a-b. It is noted, however, that the data does not need to be populated in the efficiency database in any particular manner. That is, the efficiency database does not need to include an actual plot of data as shown in FIG. 4. In other examples, the data may be stored in tables (e.g., look-up-tables or LUTs), as arrays of data, and/or in any other format suitable to determine a set point and manage efficiency of the engine-driven electric generator.

It can be seen in plots 500a-b that the power output generally increases (from left to right along the x-axis) as fuel usage increases (from bottom to top along the y-axis). The increase in power output is not necessarily on a 1:1 basis. That is, past a certain point on the plots 500a-b, more fuel is consumed by the corresponding gen-sets in order to generate incrementally more electricity. It can also be seen by comparing plots 500a-b that the individual gen-sets may have different operating efficiencies (illustrated by the offset 550 seen between lines 550a and 550b corresponding to the most efficient set points). Thus, the data has to be analyzed for each of the gen-sets to find the most efficient operating parameters (or fuel set point) to optimize efficiency of the pool of gen-sets.

In the illustration shown in plots 500a-b, the most efficient set point is generally found where there is a small dip in fuel consumption (indicated between bounds 521a-522a in plot 500a; and between bounds 521b-522b in plot 500b) in the data points 510a, 510b (respectively), while power output continues to increase. At this point (or points), the corresponding fuel set point optimizes efficient operation of the engine-driven electric generator for fuel consumption while providing the desired power output. Increasing the fuel beyond this set point will result in more fuel consumption, without a justifiable increase in power output (i.e., reducing efficiency of the gen-set). Further, reducing the fuel below this set point may not achieve the desired power output.

It should be noted that the desired power output may be specified within a tolerance. The tolerance is represented in FIGS. 5a-b by arrows 530a (530b in plot 500b) having an upper threshold 531a (531b in plot 500b) and a lower threshold 532a (532b in plot 500b). For example, the desired power output may be specified as 1000 KW +/−20%, where 1000 KW is the desired power output and +/−20% is the tolerance. The tolerance may be based on industry practice, specifications of the load being powered, or manually determined, to name only a few examples of defining a tolerance for a desired power output.

For purposes of illustration, the gen-set may be operating at a current set point 540a and 540b (indicated by the X on plots 500a-b). The efficiency management system 110 may determine a maximum value 531a (531b) and a minimum value 532a (532b) for the desired electrical power output of each gen-set. The efficiency management system 110 may then find a new set point 545a (545b) as indicated by the “O” on plots 500a-b within the specified tolerance 530a (530b) of the desired electrical power output. It can be seen that both the current set point 540a (540b) and the new set point 545a (545b) are within the tolerance 530a (530b) of the desired power output. But the new set point 545a (545b) has a lower fuel consumption. Thus, changing the current set point 540a (540b) to the new set point 545a (545b) will result in lower fuel consumption.

The efficiency management system 110 may then substitute the new set point 545a (545b) for the current set point 540a (540b) operating the individual gen-sets. These changes result in a higher operating efficiency of the individual gen-sets than was being realized by using the current set point, and hence an improvement in overall efficiency of the pool 121 of gen-sets.

Before continuing, it should be noted that the examples described above are provided for purposes of illustration, and are not intended to be limiting. Other devices and/or device configurations may be utilized to carry out the operations described herein.

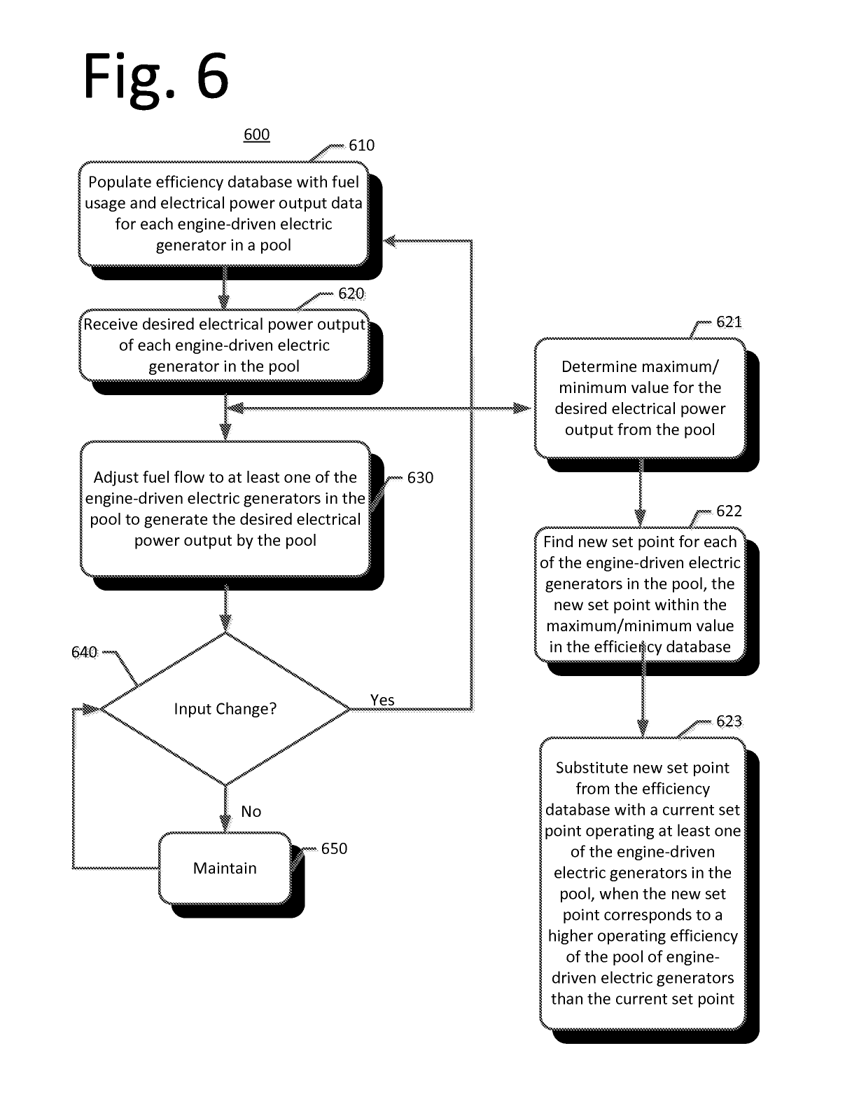

FIG. 6 is a flowchart illustrating example operations 600 which may be implemented to manage efficiency of an engine-driven electric generator. At least some of the operations 600 may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

An example method of managing an engine-driven electric generator includes at operation 610, populating an efficiency database with fuel data and electrical power output data for each engine-driven electric generator in a pool. In an example, populating the efficiency database is during an initialization operation using predetermined data. Populating the efficiency database may also be by dynamic self-populating during operation of the engine-driven electric generators.

The method also includes at operation 620, receiving a desired electrical power output of the pool of engine-driven electric generators. The desired electrical power output may include a tolerance of the desired electrical power output.

The method also includes at operation 630, adjusting fuel provided to at least one of the engine-driven electric generators in the pool to generate the desired electrical power output by the pool, using the efficiency database. Adjusting fuel provided may optimize efficient operation of the pool of engine-driven electric generators for fuel consumption while still providing the desired power output from the pool.

The method may also include a reciprocating loop, in which any input to the efficiency management system is monitored in operation 640. For example, a change of input may include operator input, such as a new desired electrical power output parameter, fuel delivery parameters, and/or efficiency data. If a change is detected, the technique may return to operation 610. If no change is detected, then the efficiency management system maintains current operations at 650 (e.g., the current set point), and continues monitoring as indicated by the loop from operation 650 to decision operation 640.

The operations shown and described herein are provided to illustrate example implementations. It is noted that the operations are not limited to the ordering shown. Still other operations may also be implemented.

For example, operation 621 determines a maximum/minimum value for the desired electrical power output from the pool. Operation 622 finds a new set point for at least one (or for each) of the engine-driven electric generators in the pool, within the maximum/minimum value in the efficiency database. Operation 623 substitutes the new set point from the efficiency database with a current set point operating at least one of the engine-driven electric generators in the pool, when the new set point corresponds to a higher operating efficiency of the pool of engine-driven electric generators than the current set point.

The operations may be implemented at least in part using an end-user interface (including but not limited to analog, digital, computer, and web-based interfaces). In an example, the operator is able to make predetermined selections, and the operations described above are implemented to manage an engine-driven electric generator. The operator can then make further selections which result in the execution of further operations. It is also noted that various of the operations described herein may be automated or partially automated.

It is noted that the examples shown and described are provided for purposes of illustration and are not intended to be limiting. Still other examples are also contemplated.

1. A method of managing a pool of engine-driven electric generators, comprising:
populating an efficiency database with fuel provided to an engine and corresponding electrical power output data from each of the engine-driven electric generators in the pool;
receiving a desired electrical power output of the pool of engine-driven electric generators; and
adjusting fuel provided to at least one of the engine-driven electric generators in the pool to generate the desired electrical power output by the pool, using the efficiency database.

2. The method of claim 1, wherein populating the efficiency database is done during an initialization operation using predetermined data for the engine-driven electric generators in the pool.

3. The method of claim 1, wherein populating the efficiency database is by dynamic and continuous self-populating during operation of the engine-driven electric generators in the pool.

4. The method of claim 1, wherein adjusting fuel provided optimizes efficient operation of the pool of engine-driven electric generators for fuel consumption while still providing the desired power output by the pool within a predetermined range.

5. The method of claim 1, wherein receiving a desired electrical power output by the pool is within specified tolerances of the desired electrical power output by the pool.

6. The method of claim 1, wherein adjusting fuel provided further comprises:
determining a maximum/minimum value for the desired electrical power output by the pool;
finding a new set point for at least one of the engine-driven electric generators in the pool, the new set point selected within the maximum/minimum value in the efficiency database; and
substituting the new set point from the efficiency database with a current set point operating at least one of the engine-driven electric generators in the pool, when the new set point corresponds to a higher operating efficiency of the pool of engine-driven electric generators than the current set point.

7. A system for managing a pool of engine-driven electric generators, comprising:
an efficiency calculator configured to populate an efficiency database with fuel provided and electrical power output data for efficient operation of the pool of engine-driven electric generators; and
a controller configured to issue a new set point for fuel provided to at least one of the engine-driven electric generators in the pool for efficient operation of the pool while generating the desired electrical power output by the pool.

8. The system of claim 7, wherein the efficiency calculator determines the new set point by:
determining maximum/minimum values for the desired electrical power output by the pool;
finding the new set point within the maximum/minimum value in the efficiency database.

9. The system of claim 8, wherein the controller adjusts fuel provided to the at least one of the engine-driven electric generators in the pool by:
substituting the new set point from the efficiency database with a current set point operating the engine-driven electric generator, when the new set point corresponds to a higher operating efficiency of the pool of engine-driven electric generators than the current set point.

10. The system of claim 7, wherein the efficiency calculator determines the set point on a substantially continuous basis during operation of the engine-driven electric generators in the pool.

11. The system of claim 7, further comprising a digital engine control unit or an analog transmitter to provide the fuel data for the efficiency database.

12. The system of claim 7, further comprising an electrical metering device to provide the electrical power output data for the efficiency database.

13. The system of claim 7, further comprising a stability calculator employing an averaging algorithm to accommodate variable efficiencies during accelerating and decelerating the engine-driven electric generators in the pool.

14. The system of claim 7, wherein the stability calculator waits for an efficiency reading to stabilize before determining an efficiency reading is valid for the efficiency database when values are changing.

15. The system of claim 7, further comprising a regulator to control generating the desired electrical power output by the pool.

16. The system of claim 15, further comprising a limit control on the regulator to maintain generating the desired electrical power output by the pool within an acceptable range specified by an operator.

17. A system for managing a pool of engine-driven electric generators, comprising:
means for storing fuel data and electrical power output data for the engine-driven electric generators in the pool;
means for receiving a desired electrical power output of the pool of engine-driven electric generators; and
means for using the efficiency database to dynamically adjust fuel provided to generate the desired electrical power output while optimizing fuel efficiency of the pool of engine-driven electric generators.

18. The system of claim 17, further comprising means for determining a new set point of at least one of the engine-driven electric generators in the pool to optimize fuel efficiency of the pool of engine-driven electric generators.

19. The system of claim 17, further comprising means for finding a new set point of at least one of the engine-driven electric generators in the pool, the new set point selected within a maximum/minimum value in the efficiency database, the new set point optimizing fuel efficiency of the pool of engine-driven electric generators.

20. The system of claim 17, means for substituting a new set point from the efficiency database with a current set point operating at least one of the engine-driven electric generators in the pool, wherein the new set point corresponds to a higher operating efficiency of the pool of engine-driven electric generators than the current set point.
